(19) United States
(12) Patent Application Publication
(10) Pub. No.: US 2006/0045350 A1
(43) Pub. Date: Mar. 2, 2006

(54) Apparatus, method and program performing image collation with similarity score as well as machine readable recording medium recording the program

(75) Inventors: Yasufumi Itoh, Tenri-shi (JP); Manabu Yumoto, Nara-shi (JP); Manabu Onozaki, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/212,710

(22) Filed: Aug. 29, 2005

(30) Foreign Application Priority Data
Aug. 30, 2004 (JP) 2004-250345

(51) Int. Cl. G06K 9/62

(52) U.S. Cl. 382/209

(57) ABSTRACT

Rectangular partial areas “Ri” for use in template matching in a process of determining match/mismatch between fingerprint images are spread adjacently to each other in one of the images. A boundary-including partial area is set in a portion including a crossing point of cross-shaped boundaries defined by the four neighboring partial areas. The plurality of partial areas formed of the neighboring partial areas and the boundary-including partial area are used as a template so that the number of the partial areas can be increased while ensuring a certain size of the partial area. Further, the boundary-including partial area covers the boundary between the neighboring partial areas so that continuity of image data at the boundary between the neighboring partial areas can be reflected in the determination of the match/mismatch between the images.

This nonprovisional application is based on Japanese Patent Application No. 2004-250345 filed with the Japan Patent Office on Aug. 30, 2004, the entire contents of which are hereby incorporated by reference.

### BACKGROUND OF THE INVENTION

1. Field of the Invention

The present invention relates to an apparatus, method and program for collating images of fingerprints or the like with each other and thereby determining whether the fingerprints or the like match with each other or not, and also relates a machine readable recording medium storing the program. In particular, the invention relates to an apparatus, method and program collating one item of input data with a plurality of items of reference data, and also relates to a machine readable recording medium storing the program.

2. Description of the Background Art

Japanese Patent Laying-Open No. 2003-323618 has disclosed an image collating apparatus which performs collation of a plurality of items of image data for determining whether these images represent the same target or not. This image collating apparatus divides one image into a plurality of partial areas for template matching, detects a position in another image where each partial area matches to the highest extent and determines whether movement vectors of these partial areas are the same or not. In this manner, the above determination of match/mismatch between the images is performed.

In this image collating apparatus, collation accuracy depends on a size of the partial area. If the partial area is excessively small (and e.g., is nearly equal to a width of a ridge of a fingerprint), it matches with another image in many positions. Therefore, the partial area must have a certain size (e.g., including three ridges of the fingerprint).

In another method, a movement of a partial area is calculated to determine whether movement vectors are the same or not, and thereby matching or mismatching is determined. In this manner, a certain number of partial areas are required for ensuring collation accuracy.

Accordingly, when the image obtained by a sensor has an excessively small size, it is impossible to ensure a sufficient number of partial areas if the apparatus is configured to prevent mutual overlapping of the partial areas, as is done in the foregoing image collating apparatus, while satisfying the foregoing conditions of the size of the partial areas.

For example, it is assumed that twenty or more partial areas are required for obtaining a necessary accuracy.

In this case, a sensor of a large area shown in FIG. 20A can satisfy the required conditions, and a sensor of a small area shown in FIG. 20B cannot satisfy the required conditions.

In the foregoing image collating apparatus, continuity of images at a boundary between the partial areas neighboring to each other is not reflected in the determination of matching or mismatching of the images based on the movement vectors. Accordingly, variations occur in a collation property depending on the manner of defining the partial areas.

For example, in the operation of collating the images in FIGS. 21A and 21B with each other, it is assumed that partial areas E1 and E2 are set without an overlap as illustrated in FIG. 21A. When a search is made for a maximum matching position of partial areas E1 and E2 in FIG. 21B, positions E1b and E2b are determined as the maximum matching positions. Accordingly, even when the images are different from each other, movement vectors may be determined as similar vectors, depending on setting of a threshold used for determining the similarity.

This is due to the fact that the property of continuity of the images is not used at a boundary between the partial areas, and a performance of detecting a difference lowers when a difference between the images occurs exactly at the boundary between the partial areas.

In summary, the foregoing image collating apparatus cannot sufficiently satisfy the two antinomic requests, i.e., the request for ensuring certain sizes of the partial areas for template matching and the request for increasing the number of the partial areas. Also, the foregoing image collating apparatus suffers from a problem that an error occurs in determination of match/mismatch between the images due to the fact that the continuity of the image data at the boundary between the neighboring partial areas is not reflected in the determination of match/mismatch between the images.

### SUMMARY OF THE INVENTION

An object of the invention is to provide an image collating apparatus, method and program which can satisfy both the two antinomic requests, i.e., the request for ensuring certain sizes of the partial areas and the request for increasing the number of the partial areas, and can also reflect the continuity of the image data at the boundary between the neighboring partial areas in the determination of match/mismatch between the images, as well as a recording medium storing the program.

For achieving the above object, an image collating apparatus according to an aspect of the invention for collating first and second images with each other includes a partial area setting unit for setting a plurality of partial areas for use in template matching in the first image. Corresponding to each of the images of the plurality of partial areas set by the partial area setting unit, a search is made for a maximum matching score position being a position in the second image of the partial area attaining a maximum matching score in the second image. For calculating the image similarity score, the apparatus uses a positional relationship quantity representing a positional relationship between a position of the partial area in the first image and the maximum matching score position corresponding to the partial area in question. Thus, a similarity score between the first and second images is calculated from information related to the partial areas exhibiting the positional relationship quantity falling within a predetermined range among the positional relationship quantities of the plurality of partial areas, and is output as an image similarity score. Based on the output image similarity score, it is determined whether the first and second images match with each other or not. The partial area setting unit includes a neighboring partial area setting unit setting a plurality of neighboring partial areas located in the first image and neighboring to each other without an overlap, and a boundary-including partial area setting unit setting a boundary-including partial area located on the neighboring partial areas set by the neighboring partial area setting unit and in a position including a boundary between the neighboring partial areas. The neighboring partial areas and the boundary-including partial area are set as the plurality of foregoing partial areas.

By setting the boundary-including partial area as described above, it is possible to satisfy both the two antinomic requests for ensuring a certain size of the partial area and for increasing the number of the partial areas, and it is possible to set the partial area having a size required for ensuring a collation accuracy and to set the partial areas of the number required for ensuring the collation accuracy. Further, the boundary-including partial area is set in the position including the boundary between the neighboring partial areas so that the boundary-including partial area can cover the boundary between the neighboring partial areas. Consequently, the continuity of the image data at the boundary between the neighboring partial areas can be reflected in determination of match/mismatch between the images as far as possible.

For achieving the foregoing object, an image collating apparatus according to another aspect of the invention for collating first and second images with each other includes a partial area image data storing unit and a boundary-including partial area image data producing unit. The partial area image data storing unit stores image data of a plurality of neighboring partial areas set in the first image for use in template matching and neighboring to each other without an overlap. The boundary-including partial area image data producing unit produces image data of a boundary-including partial area including a boundary between the neighboring partial areas neighboring to each other. Thus, image data of portions overlapping with the boundary-including partial area and included in the image data of the neighboring partial areas neighboring to each other and stored in the partial area image data storing unit is collected to produce the image data of the boundary-including partial area. In image collation, a search is made for a maximum matching score position, in the second image provided from an image input unit, of the partial area attaining the maximum matching score in the second image, corresponding to each of the images of the plurality of partial areas including the images formed of the image data of the plurality of neighboring partial areas stored in the partial area image data storing unit and the image formed of the image data of the boundary-including partial area produced by the boundary-including partial area image data producing unit. The image similarity score is calculated by using a positional relationship quantity representing a positional relationship between a position of the partial area in the first image and the maximum matching score position corresponding to the partial area in question. Thus, the similarity score between the first and second images is calculated from information related to the partial areas exhibiting the positional relationship quantity falling within a predetermined range among the positional relationship quantities of the plurality of partial areas, and is output as an image similarity score. Based on the output image similarity score, it is determined whether the first and second images match with each other or not.

As described above, by using the image of the boundary-including partial area for determining match/mismatch, it is possible to satisfy both the two antinomic requests for ensuring a certain size of the partial area and for increasing the number of the partial areas, and it is possible to set the partial area having a size required for ensuring a collation accuracy and to set the partial areas of the number required for ensuring the collation accuracy. Since the image data of the boundary-including partial area is the image data in the position including the boundary between the neighboring partial areas, the boundary-including partial area can cover the boundary between the neighboring partial areas. Consequently, the continuity of the image data at the boundary between the neighboring partial areas can be reflected in the determination of match/mismatch between the images as far as possible. Further, the image data in the boundary-including partial area is formed using the image data in the neighboring partial area. Therefore, the partial area image data storing unit for storing the image data of the neighboring partial area is not required to store additionally the image data of the boundary-including partial area, which can suppress increase in storage capacity.

Preferably, the plurality of partial areas are the partial areas all having the same rectangular shape. The neighboring partial areas are set to spread throughout the first image, and the boundary-including partial area includes a crossing point of the boundaries formed by the four neighboring partial areas neighbor to each other.

By arranging the partial areas as described above, the boundary-including partial areas can include all the boundaries of the neighboring partial areas, and the continuity of the image data at the boundary between the neighboring partial areas can be reflected in the determination of match/mismatch between the images as efficiently as possible. Further, the above configuration simplifies the calculation of the positions of the respective partial areas.

Preferably, the boundary-including partial area is the partial area restricted to a position including the boundary between the neighboring partial areas clearly exhibiting a feature of the image among all the neighboring partial areas.

By configuring the partial areas as described above, the positions clearly exhibiting the feature of the image can be concentratedly used for the determination of match/mismatch between the images, and the portions not clearly exhibiting the feature can be omitted from collation so that fast collation can be performed with a small calculation quantity.

Preferably, the similarity score calculation is executed while placing a larger weight on the similarity score calculation for the restricted boundary-including partial area clearly exhibiting the feature of the image as compared with the calculation for the other partial areas.

The above configuration performs the collation on the portions clearly exhibiting the feature of the image with a larger weight, and thereby can improve the accuracy of determination of match/mismatch between the images while simplifying the collation of the portions not clearly exhibiting the feature. Thereby, fast collation can be performed with a small calculation quantity.

Preferably, the first and second images are derived from a living body. The determination of match/mismatch between the images derived from the living body can be performed with high accuracy.

Preferably, the image derived from the living body is an image derived from a fingerprint. The determination of match/mismatch between the images derived from the fingerprints can be performed with high accuracy.

For achieving the above object, an image collating method according to still another aspect of the invention for collating first and second images with each other includes a partial area setting step of setting a plurality of partial areas for use in template matching in the first image. Corresponding to each of the images of the plurality of partial areas set in the partial area setting step, a search is made for a maximum matching score position being a position in the second image of the partial area attaining a maximum matching score in the second image. For calculating the image similarity score, the method uses a positional relationship quantity representing a positional relationship between a position of the partial area in the first image and the maximum matching score position corresponding to the partial area in question. Thus, the similarity score between the first and second images is calculated from information related to the partial areas exhibiting the positional relationship quantity falling within a predetermined range among the positional relationship quantities of the plurality of partial areas, and is output as an image similarity score. Based on the output image similarity score, it is determined whether the first and second images match with each other or not. The partial area setting step includes a neighboring partial area setting step of setting a plurality of neighboring partial areas located in the first image and neighboring to each other without an overlap, and a boundary-including partial area setting step of setting a boundary-including partial area located on the neighboring partial areas set by the neighboring partial area setting step and in a position including a boundary between the neighboring partial areas. The neighboring partial areas and the boundary-including partial area are set as the plurality of foregoing partial areas.

For achieving the foregoing object, an image collating method according to yet another aspect of the invention for collating first and second images with each other includes a partial area image data storing step and a boundary-including partial area image data producing step. The partial area image data storing step stores image data of a plurality of neighboring partial areas set in the first image for use in template matching and neighboring to each other without an overlap. The boundary-including partial area image data producing step produces image data of a boundary-including partial area including a boundary between the neighboring partial areas neighboring to each other. Thus, image data of portions included in the image data of the neighboring partial areas neighboring to each other, stored in the partial area image data storing step and overlapping with the boundary-including partial area is collected to produce the image data of the boundary-including partial area. In image collation, a search is made for a maximum matching score position, in the second image provided in the image input step, of the partial area attaining the maximum matching score by the second image corresponding to each of the images of the plurality of partial areas including the images formed of the image data of the plurality of neighboring partial areas stored in the partial area image data storing step and the image formed of the image data of the boundary-including partial area produced in the boundary-including partial area image data producing step. The image similarity score is calculated by using a positional relationship quantity representing a positional relationship between the position of the partial area in the first image and the maximum matching score position corresponding to the partial area in question. Thus, the similarity score between the first and second images is calculated from the information related to the partial area exhibiting the positional relationship quantity falling within a predetermined range among the positional relationship quantities of the plurality of partial areas, and the calculated similarity score is output as an image similarity score. Based on the output image similarity score, it is determined whether the first and second images match with each other or not.

An image collating program according to a further aspect of the invention causes a computer to execute the foregoing image collating method.

A computer readable recording medium according to a further aspect of the invention stores the foregoing image collating program.

According to the invention, since the partial area overlapping with the partial areas set in the first image and neighboring to each other is set as the partial area including the boundary between the foregoing neighboring partial areas, it is possible to set the partial area of a size required for ensuring a collation accuracy, and to set the partial areas of the number required for ensuring the collation accuracy. Further, the partial area set in the overlapping fashion is the partial area including the boundary between the neighboring partial areas, and the determination of match/mismatch is performed on the images including the image data of this partial area. Therefore, the continuity of the image at the boundary between the partial areas neighboring to each other can be reflected in the determination of match/mismatch between the images so that it is possible to suppress a disadvantageous determination error which may be caused by the fact that the continuity at the boundary between the partial areas is not reflected in the movement of the image.

Further, in the case where the image data of the boundary-including partial area is produced by using the image data of the neighboring partial area, the partial area image data storing unit for storing the image data of the neighboring partial area is not required to store additionally the image data of the boundary-including partial area, and this suppresses increase in storage capacity.

In the case where an overlapping partial area setting unit sets the partial areas concentratedly in a portion clearly exhibiting the feature of the image, accurate collation can be performed fast. Thus, by arranging the partial areas as described above, the collation can be performed while placing a larger weight on a part of the image, and the collation of the portions not clearly exhibiting the feature can be simplified so that fast calculation can be performed with a small calculation quantity.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an image collating apparatus according to a first embodiment.

FIG. 2 illustrates a configuration of a computer equipped with the image collating apparatus according to each embodiment.

FIG. 3 is a flowchart of an image collating procedure according to each embodiment.

FIG. 4 is a processing flowchart for template matching of images and calculation of a similarity score according to the first embodiment.

FIG. 5 is a flowchart of template setting processing of a partial area “Ri” illustrated in FIG. 4.

FIGS. 6A and 6B illustrate setting of a partial area in the first embodiment.

FIGS. 7A and 7B illustrate an example of collation according to the invention.

FIG. 8 is a block diagram of an image collating apparatus according to a second embodiment.

FIG. 9 is a flowchart of similarity score calculating processing according to the second embodiment.

FIG. 10 is a flowchart of template setting processing of a partial area “Ri” in the second embodiment.

FIGS. 11A and 11B are flowcharts of addition processing of Pi in the second embodiment.

FIG. 12 illustrates an example of setting of weighted partial areas according to the invention.

FIG. 13 is a block diagram of an image collating apparatus according to a third embodiment.

FIG. 14 is a flowchart of image registering processing in the third embodiment.

FIG. 15A is a flowchart of processing of extracting “Ri” in the third embodiment, and FIG. 15B illustrates an extraction state of “Ri” according to the flowchart.

FIG. 16A is a flowchart of template setting processing of partial area “Ri” in the third embodiment, and FIG. 16B illustrates divided areas of neighboring partial area “Ri” in the third embodiment.

FIG. 17 is a block diagram of an image collating apparatus in a fourth embodiment.

FIG. 18A is a flowchart of processing of extracting “Ri” in the fourth embodiment, and FIG. 18B illustrates a specific extraction state of “Ri” according to the flowchart.

FIG. 19 is a flowchart of template setting processing of partial area “Ri” in the fourth embodiment.

FIGS. 20A and 20B illustrate an example of setting of partial areas in a prior art.

FIGS. 21A and 21B illustrate an example of collation in the prior art.

### DESCRIPTION OF THE PREFERRED EMBODIMENTS

Embodiments of the invention will now be described with reference to the drawings.

Here, two image data are collated with each other. Though fingerprint data will be described as an exemplary image data to be collated, the image is not limited thereto, and the present invention may be applicable to image data of other biometrics that are similar among samples (individuals) but not identical, or other image data of linear patterns.

### First Embodiment

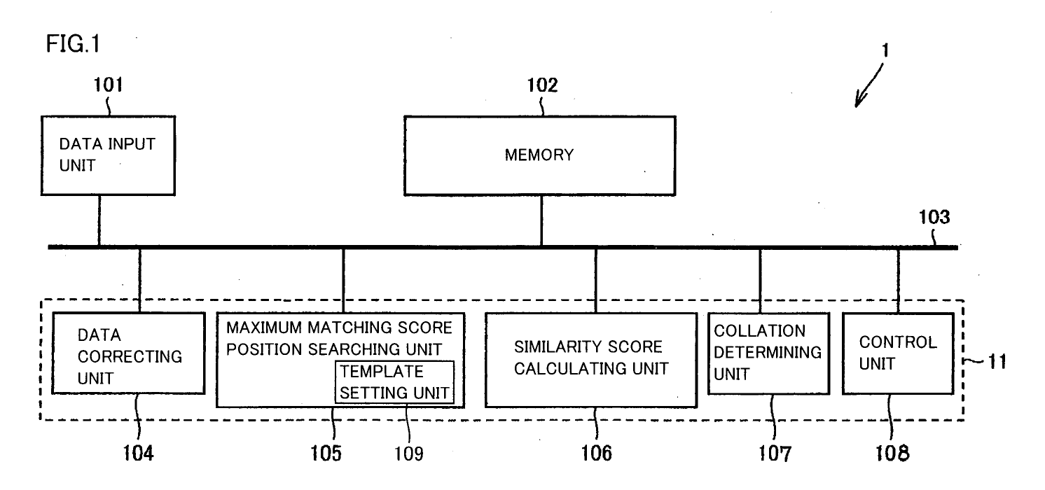

FIG. 1 illustrates a block structure of an image collating apparatus 1 according to a first embodiment.

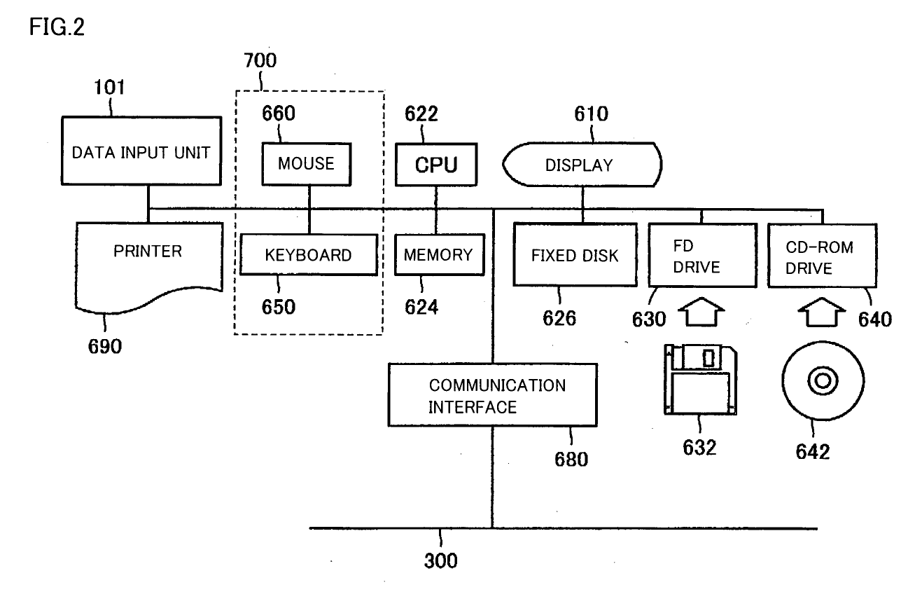

FIG. 2 illustrates a computer equipped with the image collating apparatus according to each embodiment. FIG. 2 shows a configuration of a computer in which the image collating apparatus in accordance with various embodiments is mounted. Referring to FIG. 2, the computer includes an image input unit 101, a display 610 such as a CRT (Cathode Ray Tube) or a liquid crystal display, a CPU (Central Processing Unit) 622 for central management and control of the computer itself, a memory 624 including an ROM (Read Only Memory) or an RAM (Random Access Memory), a fixed disk 626, an FD drive 630 on which an FD (flexible disk) 632 is detachably mounted and which accesses to FD 632 mounted thereon, a CD-ROM drive 640 on which a CD-ROM (Compact Disc Read Only Memory) 642 is detachably mounted and which accesses to the mounted CD-ROM 642, a communication interface 680 for connecting the computer to a communication network 300 for establishing communication, and an input unit 700 having a key board 650 and a mouse 660. These components are connected through a bus for communication.

The computer may be provided with a magnetic tape apparatus accessing to a cassette type magnetic tape that is detachably mounted thereto.

Referring to FIG. 1, image collating apparatus 1 includes image input unit 101, a memory 102 that corresponds to memory 624 or fixed disk 626 shown in FIG. 2, a bus 103 and a collating unit 11. Collating unit 11 includes an image correcting unit 104, a maximum matching score position searching unit 105, a movement-vector-based similarity score calculating unit (hereinafter referred to as a similarity score calculating unit) 106, a collation determining unit 107 and a control unit 108. Functions of these units in collating unit 11 are realized when corresponding programs are executed. Maximum matching score position searching unit 105 has a template setting unit 109.

Image input unit 101 includes a fingerprint sensor 100, and outputs a fingerprint image data that corresponds to the fingerprint read by fingerprint sensor. Fingerprint sensor may be an optical, a pressure-type, a static capacitance type or any other type sensor. Memory 102 stores image data and various calculation results. Bus 103 is used for transferring control signals and data signals between each of these units. Image correcting unit 104 performs density correction of the fingerprint image input from image input unit 101. Maximum matching score position searching unit 105 uses a plurality of partial areas of one fingerprint image as templates, and searches for a position of the other fingerprint image that attains to the highest matching score with the templates. Namely, this unit serves as a so called template matching unit. Using the information of the result from maximum matching score position searching unit 105 stored in memory 102, similarity score calculating unit 106 calculates the movement-vector-based similarity score, which will be described later. Collation determining unit 107 determines a match/mismatch, based on the similarity score calculated by similarity score calculating unit 106. Control unit 108 controls processes performed by various units of collating unit 11.

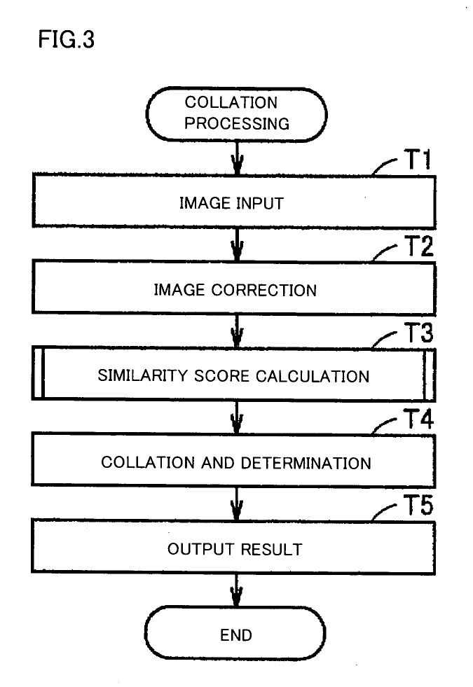

The procedure for collating images “A” and “B” that correspond to data of two fingerprint images, for collating two fingerprint images in image collating apparatus 1 shown in FIG. 1 will be described with reference to the flow chart of FIG. 3.

First, control unit 108 transmits an image input start signal to image input unit 101, and thereafter waits until an image input end signal is received. Image input unit 101 receives as an input image “A” for collation, and received image “A” is stored at a prescribed address of memory 102 through bus 103 (step T1). After the input of image “A” is completed, image input unit 101 transmits the image input end signal to control unit 108.

Receiving the image input end signal, control unit 108 again transmits the image input start signal to image input unit 101, and thereafter, waits until the image input end signal is received. Image input unit 101 receives as an input image “B” for collation, and received image “B” is stored at a prescribed address of memory 102 through bus 103 (step T1). After the input of image “B” is completed, image input unit 101 transmits the image input end signal to control unit 108.

Thereafter, control unit 108 transmits an image correction start signal to image correcting unit 104, and thereafter, waits until an image correction end signal is received. In most cases, the input image has uneven image quality, as tones of pixels and overall density distribution vary because of variations in characteristics of image input unit 101, dryness of fingerprints and pressure with which fingers are pressed. Therefore, it is not appropriate to use the input image data directly for collation. Image correcting unit 104 corrects the image quality of input image to suppress variations of conditions when the image is input (step T2). Specifically, for the overall image corresponding to the input image or small areas obtained by dividing the image, histogram planarization, as described in Computer GAZOU SHORI NYUMON (Introduction to computer image processing), SOKEN SHUPPAN, p. 98, or image thresholding (binarization), as described in Computer GAZOU SHORI NYUMON (Introduction to computer image processing), SOKEN SHUPPAN, pp. 66-69, is performed, on images “A” and “B” stored in memory 102.

After the end of image correcting process on images “A” and “B”, image correcting unit 104 transmits the image correction end signal to control unit 108.

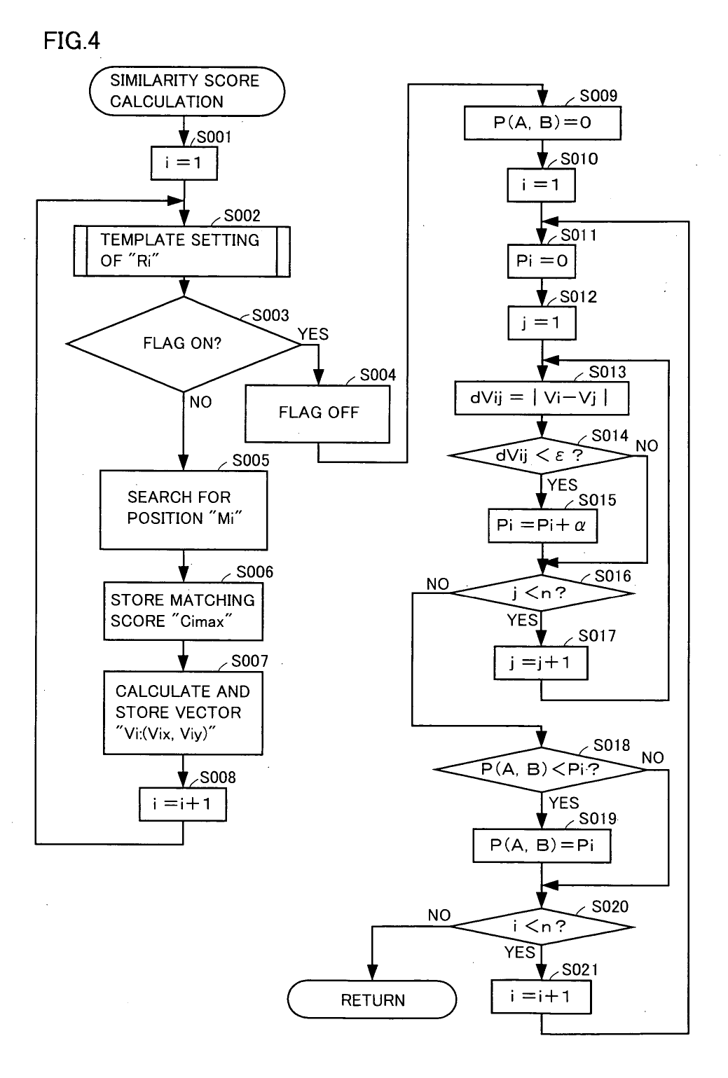

Thereafter, on the images “A” and “B” that have been subjected to image correcting process by image correcting unit 104, the collation (step T3) is performed. This processing will be described with reference to FIG. 4.

Control unit 108 transmits a template matching start signal to maximum matching score position searching unit 105, and waits until a template matching end signal is received. Maximum matching score position searching unit 105 starts a template matching process represented by steps S001 to S008. In step S001, a counter variable “i” is initialized to “1”. In step S002, an image of a partial area defined as partial area “Ri” of image “A” is set as a template to be used for the template matching.

FIG. 5 illustrates a flowchart of a subroutine program of template setting processing of partial area “Ri” performed by template setting unit 109 in step S002. Referring to FIG. 5, description will now be given on the template setting processing of partial area “Ri”. In step S030, it is determined whether partial area “Ri” can be set in image “A” without an overlap or not. When an area, in which partial area “Ri” can be set without an overlap, is still left in image “A”, the result of determination in step S030 is “YES”, and partial area (neighboring partial area) “Ri” neighboring without an overlap is set as the template in step S031.

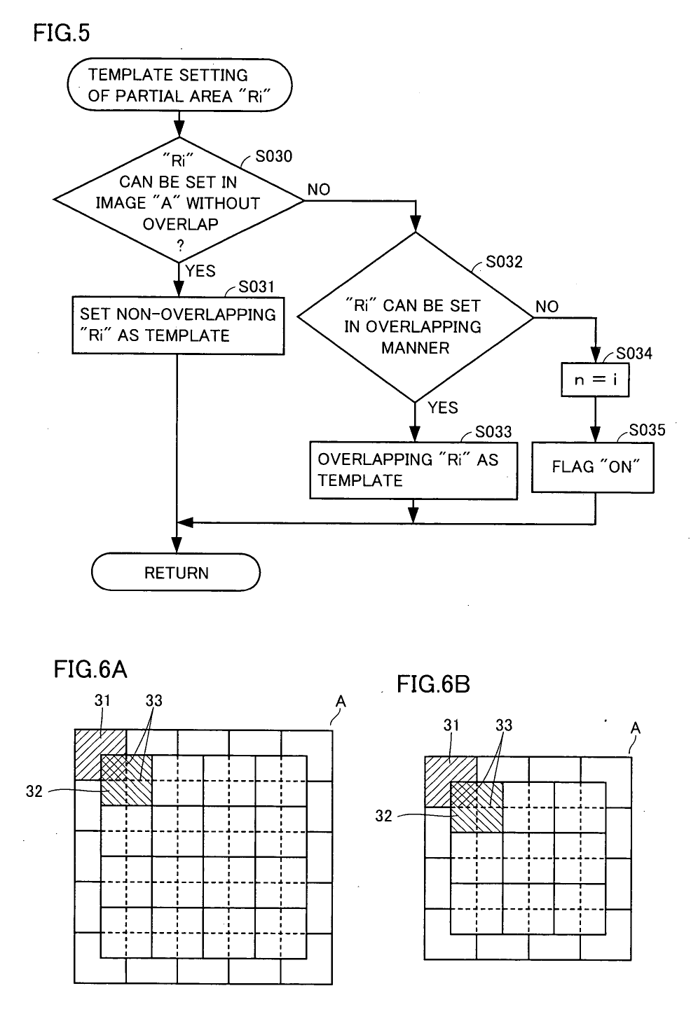

When there is no area that allows setting of neighboring partial area “Ri” in image “A” without an overlap, the result of determination in step S030 is “NO”, and it is determined in step S032 whether it is possible to set partial area “Ri” at a center of the area formed of four neighboring templates (i.e., neighboring templates) in an overlapping fashion or not. This overlapping partial area “Ri” is a partial area indicated by a reference number “32” in FIGS. 6A and 6B, and set to overlap with centers of the partial areas formed of neighboring four templates indicated by a reference 31, and is a boundary-including partial area including boundaries 33 of the four neighboring partial areas represented by broken lines. When there is left an area that allows setting of overlapping boundary-including partial area “Ri” in image “A”, the result of determination in step S032 is “YES”, and processing is performed in step S033 to set overlapping boundary-including partial area “Ri” as the template. Conversely, when there is no area that allows setting of boundary-including partial area “Ri”, the result of determination in step S032 is “NO”, and a value of a variable “n” is assigned to the value of variable “i”. In subsequent step S035, a template setting completion flag is set to “ON”. The value of variable “n” assigned to variable “i” in step S034 indicates a total number of partial areas “Ri” set in image “A” (i.e., a total number of the neighboring partial areas indicated by reference number “31” and the boundary-including partial areas indicated by reference number “32”). FIG. 6A illustrates the neighboring partial areas of 25 in number and the boundary-including partial areas of 16 in number. FIG. 6B illustrates the neighboring partial areas of 16 in number and the boundary-including partial areas of 9 in number.

Though the partial area “Ri” has a rectangular shape for simplicity of calculation, the shape is not limited thereto. Returning to FIG. 4, it is determined in step S003 whether the template setting completion flag is “ON” or not. When the processing in foregoing step S035 is not yet performed, the result of determination in step S003 is “NO” so that loop processing in the order of step S005, step S006, step S007, step S008, step S002 and step S003 is repeated. Every time this loop processing is repeated, the value of variable “i” is incremented by one in step S008, and the template setting of partial area “Ri” is performed in step S002. When the overlapping boundary-including partial areas “Ri” are set throughout image “A”, the template setting completion flag is set to “ON” in step S035. Thereby, the result of determination in step S003 becomes “YES”, and the template setting completion flag is set to “OFF” in step S004. Thereafter, the process proceeds to step S009.

In step S005, a search is made for a position where the highest matching score is attained with respect to the template set in step S002, and thus the position where the data in the image matches with it to the highest extent. More specifically, we represent pixel density of coordinates (x, y), with an upper left corner of partial area “Ri” used as the template being the origin by “Ri (x, y)”, pixel density of coordinates (s, t), with an upper left corner of image “B” being the origin by “B(s, t)”, the width and height of partial area “Ri” by “w” and “h”, respectively, possible maximum density of each pixel in images “A” and “B” by “V0”, and the matching score at coordinates (s, t) of image “B” by “Ci(s, t)”. This matching score “Ci(s, t)” is calculated in accordance with the following equation (1), based on a density difference between of the pixels.

$$Ci ( s , t ) = {\sum }_{y = 1}^{h} {\sum }_{x = 1}^{w} ( V0 - \vert Ri ( x , y ) - B ( s + x , t + y ) \vert ) \qquad ( 1 )$$

In image “B”, the coordinates (s, t) are successively updated and the matching score “C(s, t)” is calculated. A position having the highest value is considered as the maximum matching score position, the image of the partial area at that position is represented as partial area “Mi”, and the matching score at that position is represented as maximum matching score “Cimax”. In step S006, the maximum matching score “Cimax” in image “B” for the partial area “Ri” calculated in step S005 is stored at a prescribed address of memory 102. In step S007, a movement vector “Vi” is calculated in accordance with equation (2) and is stored at a prescribed address of memory 102.

Here, if the image “B” is scanned to identify the partial area “Mi” at the position “M” having the highest matching score with the partial area “Ri”, based on the partial area “Ri” at position “P” in image “A”, a directional vector from position “P” to position “M” is referred to as a movement vector. This is because the image “B” seems to have moved from image “A” as a reference, as the finger is placed in various manners on the fingerprint sensor.
Vi=(Vix, Viy)=(Mix−Rix, Miy−Riy) (2)

In equation (2), variables “Rix” and “Riy” are “x” and “y” coordinates at the reference position of partial area “Ri”, that correspond, by way of example, to the upper left corner of partial area “Ri” in image “A”. Variables “Mix” and “Miy” are “x” and “y” coordinates at the position of maximum matching score “Cimax” as the result of search of partial area “Mi”, which correspond, by way of example, to the upper left corner coordinates of partial area “Mi” at the matched position in image “B”.

Steps S002 to S008 are repeated, and template matching is performed on every partial area “Ri”. Also, the maximum matching score “Cimax” of each partial area “Ri” and the movement vector “Vi” are calculated. As described above, when there is no area that allows setting of boundary-including partial area “Ri” in image “A”, the process proceeds from step S004 to step S009.

Maximum matching score position searching unit 105 stores the maximum matching score “Cimax” and the movement vector “Vi” for every partial area “Ri” calculated successively as described above at prescribed addresses of memory 102, and thereafter transmits a template matching end signal to control unit 108 to end the processing.

Thereafter, control unit 108 transmits a similarity score calculation start signal to similarity score calculating unit 106, and waits until a similarity score calculation end signal is received. Similarity score calculating unit 106 calculates the similarity score through the process of steps S009 to S021 of FIG. 4, using information such as the movement vector “Vi” and the maximum matching score “Cimax” of each partial area “Ri” obtained by template matching and stored in memory 102.

In step S009, similarity score “P (A, B)” is initialized to 0. Here, the similarity score “P(A, B)” is a variable storing the degree of similarity between images “A” and “B”. In step S010, an index “i” of the movement vector “Vi” as a reference is initialized to “1”. In step S011, similarity score “Pi” related to the reference movement vector “Vi” is initialized to “0”. In step S012, an index “j” of movement vector “Vj” is initialized to “1”. In step S013, vector difference “dVij” between reference movement vector “Vi” and movement vector “Vj” is calculated in accordance with equation (3).
dVij=|Vi−Vj|=sqrt((Vix−Vjx)ˆ2+(Viy−Vjy)ˆ2) (3)

Here, variables “Vix” and “Viy” represent “x” direction and “y” direction components, respectively, of the movement vector “Vi”, variables “Vjx” and “Vjy” represent “x” direction and “y” direction components, respectively, of the movement vector “Vj”, variable “sqrt(X)” represents square root of “X” and “Xˆ2” represents calculation of square of “X”.

In step S014, vector difference “dVij” between movement vectors “Vi” and “Vj” is compared with a prescribed constant value “ε”, so as to determine whether the movement vectors “Vi” and “Vj” can be regarded as substantially the same vectors. If the vector difference “dVij” is smaller than the constant value “ε”, movement vectors “Vi” and “Vj” are regarded as substantially the same, and the flow proceeds to step S015. If the difference is larger than the constant value, the movement vectors cannot be regarded as substantially the same, and the flow proceeds to step S016. In step S015, the similarity score “Pi” is incremented in accordance with equations (4) to (6).
Pi=Pi+a (4)
α=1 (5)
α=Cimax (6)

In equation (4), variable “α” is a value for incrementing the similarity score “Pi”. If “α” is set to 1 as represented by equation (5), similarity score “Pi” represents the number of partial areas that have the same movement vector as reference movement vector “Vi”. If “α” is set to Cimax as represented by equation (6), the similarity score “Pi” would be the total sum of the maximum matching scores obtained through the template matching of partial areas that have the same movement vector as the reference movement vector “Vi”. The value of variable “α” may be made smaller, in accordance with the magnitude of vector difference “dVij”.

In step S016, whether the value of index “j” is smaller than the total number “n” of partial areas or not is determined. If the value of index “j” is smaller than the total number “n” of partial areas, the flow proceeds to step S017, and if it is larger, the flow proceeds to step S018. In step S017, the value of index “j” is incremented by 1. By the process from step S011 to S017, the similarity score “Pi” is calculated, using the information of partial areas determined to have the same movement vector as the reference movement vector “Vi”. In step S018, the similarity score “Pi” using movement vector “Vi” as a reference is compared with the variable “P(A, B)”, and if the similarity score “Pi” is larger than the largest similarity score (value of variable “P(A, B)”) obtained by that time, the flow proceeds to step S019, and otherwise the flow proceeds to step S020.

In step S019, a value of similarity score “Pi” using movement vector “Vi” as a reference is assigned to the variable “P(A, B)”. In steps S018 and S019, if the similarity score “Pi” using movement vector “Vi” as a reference is larger than the maximum value of the similarity score (value of variable “P(A, B)”) calculated by that time using other movement vector as a reference, the reference movement vector “Vi” is considered to be the best reference among the values of index “i” used to that time point.

In step S020, the value of index “i” of reference movement vector “Vi” is compared with the number (value of variable “n” set in step S034) of partial areas. If the value of index “i” is smaller than the number “n” of partial areas, the flow proceeds to step S021, in which the index value “i” is incremented by 1.

From step S009 to step S021, similarity between images “A” and “B” is calculated as the value of variable “P(A, B)”. Similarity score calculating unit 106 stores the value of variable “P(A, B)” calculated in the above described manner at a prescribed address of memory 102, and transmits a similarity score calculation end signal to control unit 108 to end the process.

Thereafter, control unit 108 transmits a collation determination start signal to collation determining unit 107, and waits until a collation determination end signal is received (step T4). Collation determining unit 107 collates and determines (step T4). Specifically, the similarity score represented by the value of variable “P(A, B)” stored in memory 102 is compared with a predetermined threshold “T” for collation. As a result of comparison, if “P(A, B)”≧T, it is determined that images “A” and “B” are taken from one same fingerprint, a value, for example, “1”, indicating a “match” is written to a prescribed address of memory 102 as a collation result, and if not, the images are determined to be taken from different fingerprints and a value, for example, “0”, indicating a “mismatch” is written at a prescribed address of memory 102 as a collation result. Thereafter, a collation determination end signal is transmitted to control unit 108, and the process ends.

Finally, control unit 108 outputs the collation result stored in memory 102 through display 610 or printer 690 (step T5), and the image collating process ends.

In the present embodiment, part of or all of image correcting unit 104, maximum matching score position searching unit 105, similarity score calculating unit 106, collation determining unit 107 and control unit 108 may be implemented by an ROM such as memory 624 storing the process procedure as a program and a processor such as CPU 622.

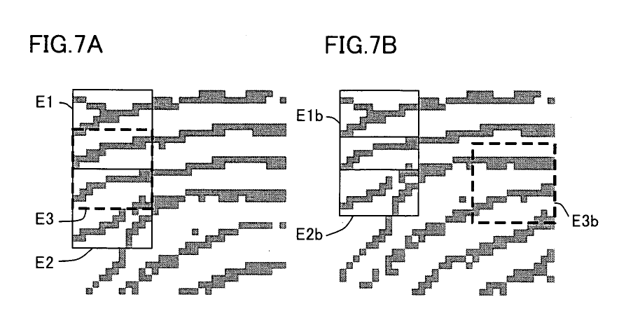

FIGS. 7A and 7B illustrate an effect achieved by setting the partial areas overlapping together, and this will be described later in detail.

### Second Embodiment

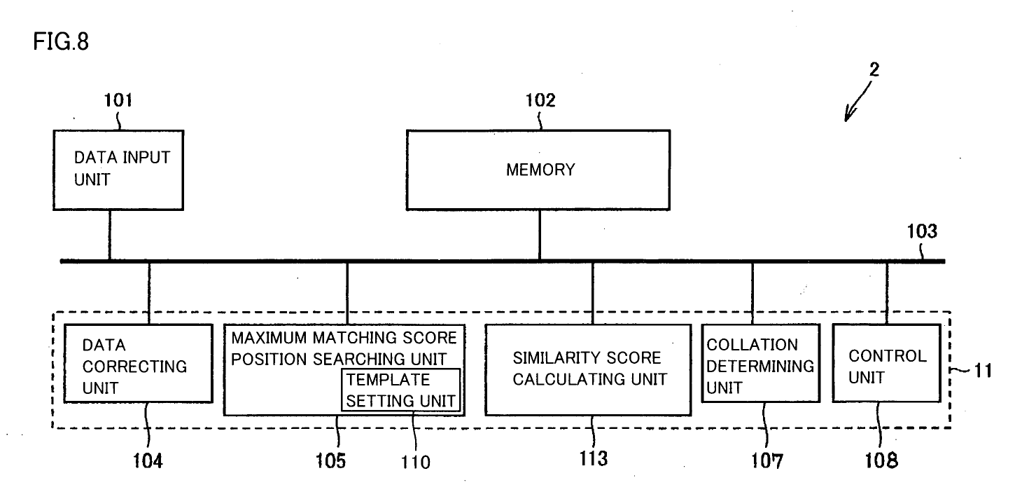

In the first embodiment already described, after the partial areas neighboring to each other are set in the image, the boundary-including partial area is set in the overlapping manner on the above partial area, and the setting of the partial area ends when the area allowing the setting of the boundary-including partial area is no longer left. In contrast to this control, a second embodiment performs the control such that setting of the partial areas ends when the partial areas equal in number to a predetermined value of variable “n” are set. This second embodiment will now be described with reference to FIGS. 8-12. FIG. 8 illustrates a structure of an image collating apparatus 2 according to the second embodiment. Image collating apparatus 2 has the same structure as image collating apparatus 1 except for that similarity score calculating unit 106 of image collating apparatus 1 is replaced with a similarity score collating unit 113, and template setting unit 109 is replaced with a template setting unit 110.

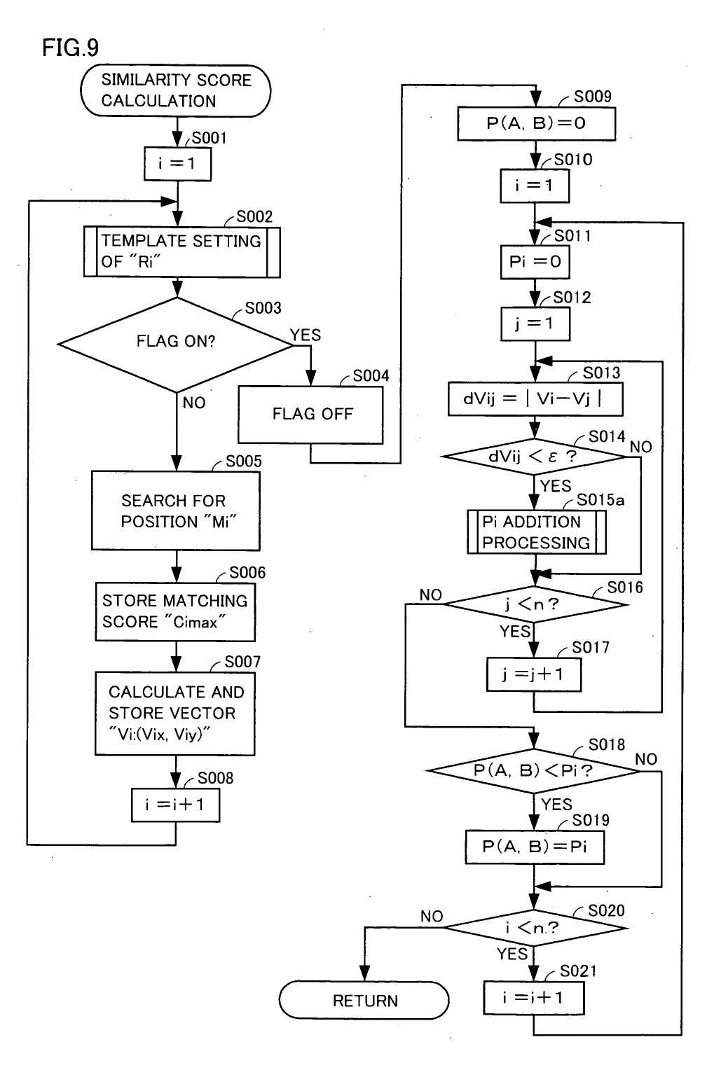

FIG. 9 is a flowchart illustrating similarity score calculation. This similarity score calculation differs from that of the first embodiment illustrated in FIG. 4 in specific details of the template setting processing of partial area “Ri” in step S002 by template setting unit 110 as well as specific details of addition processing of “Pi” in step S015a by similarity score collating unit 113. Processing other than the above is the same as that in the first embodiment illustrated in FIG. 4.

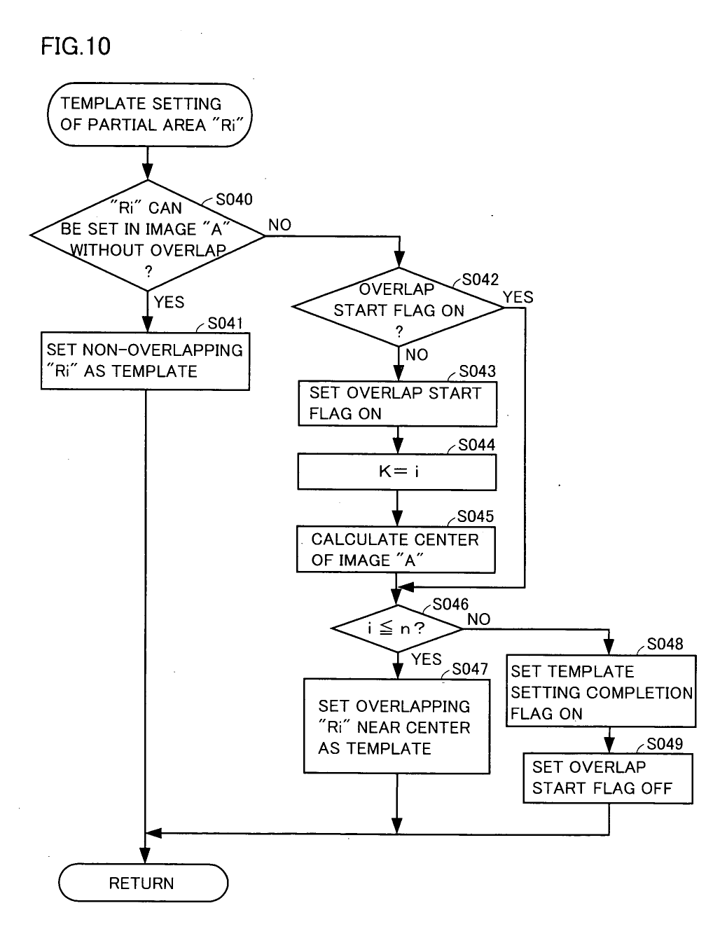

FIG. 10 is a flowchart of a subroutine program of the template setting processing of partial area “Ri” in step S002 of FIG. 9. Referring to FIG. 10, it is determined in step S040 whether partial area “Ri” can be set in image “A” without an overlap or not. When possible, processing is performed in step S041 to set neighboring partial area “Ri”, which does not overlap, as a template. When the area allowing setting of neighboring partial area “Ri” without an overlap is no longer left after setting neighboring partial area “Ri” in image “A” without an overlap, the result of determination in step S040 becomes “NO”, and it is determined in step S042 whether the overlap start flag is “ON” or not. When the template setting processing of the neighboring partial area “Ri” in image “A” is first executed after all the areas are used for setting neighboring partial areas “Ri” in image “A” without an overlap, an overlap start flag is not “ON” so that processing is performed in step S043 to set the overlap start flag to “ON”. In next step S044, processing is performed to set overlap start value K to i (K=i). Thus, variable “i” indicating the current number of partial areas is set to overlap start value “K” when no area is left for the setting without an overlap as a result of the processing of setting neighboring partial areas “Ri” in image “A” without an overlap.

In next step S045, a center of image “A” is calculated. In next step S046, it is determined whether a relationship of (i≦n) is satisfied or not. Variable “n” indicates the predetermined total number of the partial areas to be set in image “A”. Variable “n” is preset to satisfy the relationship that variable “n” is larger than the number of neighboring partial areas “Ri” spread throughout image “A” without an overlap, and is smaller than the number of the total number of partial areas in the state where the boundary-including partial areas are fully spread over the neighboring partial areas.

When a current value of “i” is smaller than that of “n”, the flow proceeds to step S047, in which boundary-including partial area “Ri” is set as the template in a position near the center of image “A” calculated in step S045. One is added to “i” in step S008 in response to every execution of the processing in step S047, and the processing in step S047 is repeated until the value of “i” reaches the value of “n”. When the result of determination in step S040 first becomes “NO”; the overlap start flag is set to “ON”. For the subsequent processing, therefore, the result of determination becomes “YES” in step S042, and the flow directly proceeds to step S046 without performing the processing in steps S043-S045.

When the value of variable “i” reaches that of variable “n”, the template setting completion flag is set to “ON” in step S048, and the overlap start flag is set to “OFF” in step S049.

As a result of the processing in step S047, boundary-including partial areas “Ri” are arranged such that higher priority is given to the arrangement of boundary-including partial areas “Ri” at the center of image “A”, i.e., at the position where the feature of the image becomes clear in the case where the target image is a fingerprint.

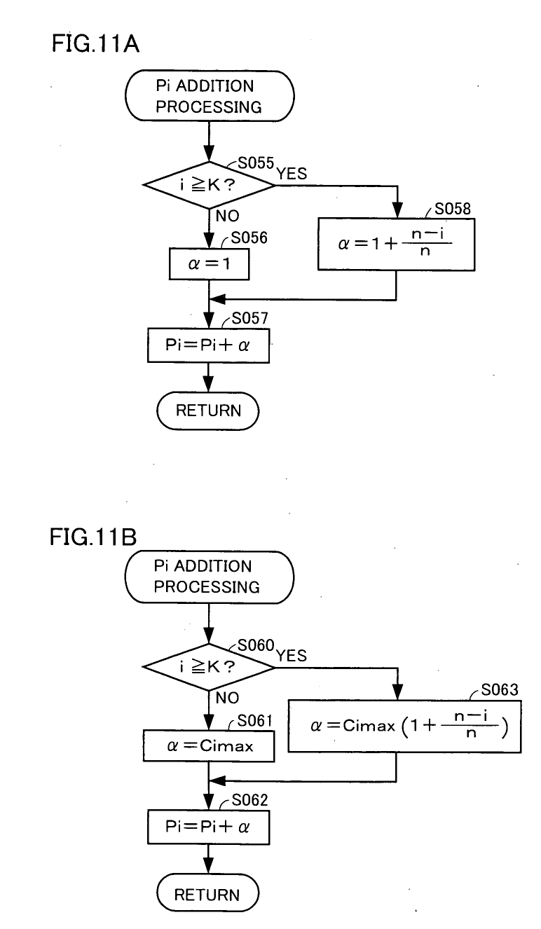

FIG. 11A illustrates a first example of a flowchart of the subroutine program of “Pi” addition processing illustrated in step S015a in FIG. 9, and FIG. 11B illustrates a second example thereof.

Referring first to FIG. 11A, it is determined in step S055 whether the current value of “i” is equal to or larger than an overlap start value “K” set in foregoing step S044 or not. When it is smaller than value “K”, i.e., when setting of the boundary-including partial area is not yet performed, the value of “α” is set to “1” in step S056, and the current value of “Pi” is updated by adding “a” thereto in step S057.

When the current value of “i” is equal to or larger than start value “K”, i.e., when the setting of the boundary-including partial area is already performed, processing is performed according to “α=1+(n−i)/n” in step S058. In step S057, the value of “α” set in step S058 is added to the current value of “Pi” in step S057.

In “α=1+(n−i)/n” used in step S058, the value of “α” decreases with increase in value of “i”, and becomes “1” when the value of “i” reaches the maximum value, i.e. the value of variable “n”. In step S047, therefore, boundary-including partial areas “Ri” are set in the position near the center on a priority basis so that boundary-including partial area “Ri” closer to the center exhibits the “α” of a larger value, and the value of “α” gradually decreases with a distance from the center. Consequently, the determination of match/mismatch between the images is performed while placing larger weights on central portions exhibiting the feature in the image.

In another example of the addition processing of “Pi” illustrated in FIG. 11B, when the result of determination in step S060 is “NO”, processing is performed according to “α=Cimax” in step S061. In step S062, the value of α set in step S061 is added to the current value of “Pi”.

When the result of determination in step S060 is “YES”, processing is performed according to (α=Cimax(1+(n−i)/n)) in step S063. In this step S063, the value of “α” decreases with increase in value of “i”, and becomes “Cimax” when the value of “i” reaches the maximum value, i.e. the value of variable “n” similarly to the foregoing step S058. Therefore, in the example illustrated in FIG. 11B, larger weights are likewise placed on central portions clearly exhibiting the features in the image when determining the match/mismatch between images.

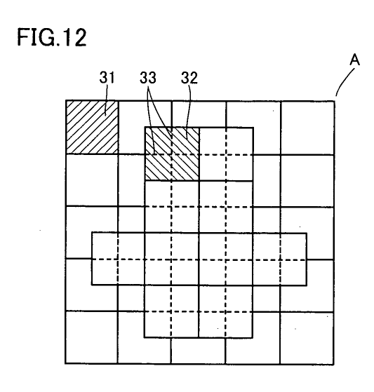

FIG. 12 illustrates a state of setting the boundary-including partial areas in the second embodiment. As described above, the boundary-including partial areas indicated by reference numbers “32” are set concentratedly in the central portion clearly exhibiting the feature of the image, and the boundary-including partial area is not set in the peripheral portion not clearly exhibiting the feature. Owing to this state of setting, the collation can be efficiently performed with high collation accuracy.

### Third Embodiment

In the first and second embodiments, images “A” and “B” to be collated are provided from image input unit 101. In a third embodiment, however, one of two images to be collated is registered in advance, and only the other image is provided.

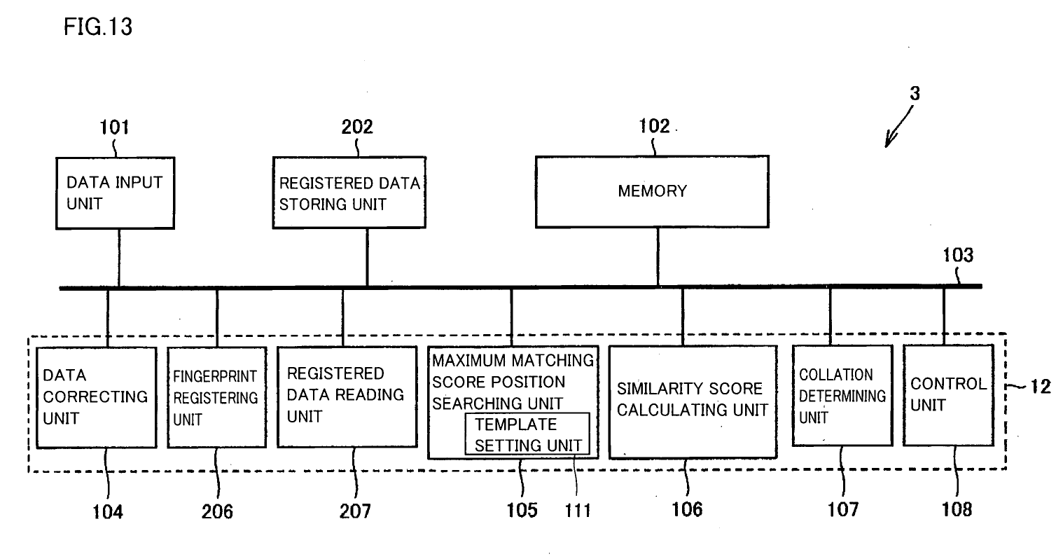

FIG. 13 is a block diagram of an image collating apparatus according to the third embodiment. Image collating apparatus 3 in FIG. 13 differs from image collating apparatus 1 in FIG. 1 in that image collating apparatus 3 includes a registered data storing unit 202 in addition to the structures of image collating apparatus 1, and further includes a collation processing unit 12 in place of collation processing unit 11. In addition to the structure of collation processing unit 11, collation processing unit 12 has a fingerprint registering unit 206 and a registered data reading unit 207. Further, maximum matching score position searching unit 105 has a template setting unit 111 instead of template setting unit 109.

Registered data storing unit 202 stores in advance only data portion to be used for collation in one of the image to be collated. Fingerprint registering unit 206 extracts the information required for collation from the fingerprint image provided from image input unit 101, and stores it in registered data storing unit 202. Registered data reading unit 207 reads the information required for collation from registered data storing unit 202, and stores the read information in memory 102.

First, it is assumed that images “A” and “B” form the image pair to be collated. In general, one of the images is stored in registered data storing unit 202, and is collated with the other images, which are successively input. Thereby, it is determined whether the registered image and the input image are derived from the same fingerprint or not. In this example, image “A” is the registered image, and image “B” is the input image.

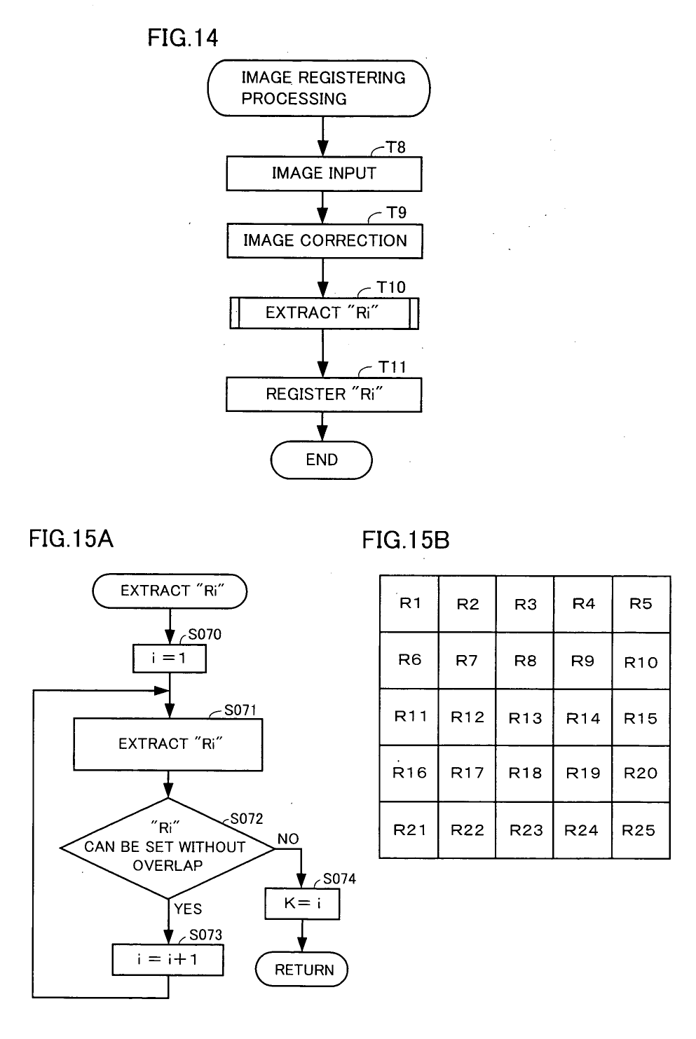

The processing of registering image “A” as the registered image will now be described according to the flowchart of FIG. 14.

First, control unit 108 transmits an image input start signal to image input unit 101, and then waits until an image input end signal is received. Image input unit 101 performs the input of image “A”, and stores it through bus 103 at a prescribed address in memory 102 (step T8). When the image input is completed, image input unit 101 transmits an image input end signal to control unit 108.

Then, control unit 108 transmits the image correction start signal for image “A” to image correcting unit 104, and waits until the image correction end signal is received. Image correcting unit 104 effects image quality correction, which is already described in connection with the first embodiment, on image “A” stored in memory 102 (step T9). Thereafter, it transmits the image correction end signal to control unit 108.

Then, control unit 108 transmits a fingerprint registration start signal to fingerprint registering unit 206, and waits until a fingerprint registration end signal is received. Fingerprint registering unit 206 extracts data of partial areas (neighboring partial areas) R1, R2, . . . Rn in the predetermined positions, e.g., illustrated in FIG. 15B from image “A” in memory 102 (step T10), and successively stores the data at the prescribed addresses in registered data storing unit 202 (step T11). Thereafter, fingerprint registering unit 206 transmits the fingerprint registration end signal to control unit 108. Thereby, the apparatus ends the registration processing of extracting the partial areas (neighboring partial areas) “Ri” used for collation and storing them as registered image “A”.

In this embodiment, all or a part of image correcting unit 104, fingerprint registering unit 206, registered data reading unit 207, maximum matching score position searching unit 105, similarity score calculating unit 106, collation determining unit 107 and control unit 108 may be implemented by a ROM corresponding to memory 624 storing a processing procedure and a processor such as CPU 622 for executing the stored procedure.

FIG. 15A is a flowchart illustrating a subroutine program for extracting “Ri” illustrated in T10 of FIG. 14. First, the initial value of “i” is set to “1” in step S070. In next step S071, processing is performed to extract neighboring partial area “Ri” from the left column in the upper row of the input image. In next step S072, it is determined whether neighboring partial area “Ri” can be set in the input image without an overlap or not. When an area allowing setting without an overlap is still left, next control is performed in step S073 to add “1” to the value of “i”, and the flow returns to step S071.

Until the result of determination becomes “NO”, the processing in steps S071-S073 is repeated. Consequently, as illustrated in FIG. 15B, neighboring partial areas R1, R2, . . . are set while changing the position from the left end in the uppermost row of the input image toward the right end thereof. After neighboring partial area R5 is set at the right end in the uppermost row, neighboring partial areas R6, R7, . . . R10 are set while changing the position from the left end toward the right end in the next row. When last neighboring partial area R25 is set after repeating the above setting, the result of determination in step S072 becomes “NO”. When the result of determination in step S072 becomes “NO”, the current value of “i” is assigned to the value of “K” in step S074. Consequently, the total number of the neighboring partial areas becomes equal to the value of “K” in the case where the neighboring partial areas neighboring to each other are set throughout the input image without an overlap.

The flowchart of the collating processing of collating image “B” serving as the input image with the registered data is the same as that in FIG. 3. The flowchart of similarity score calculation is the same as that in FIG. 4.

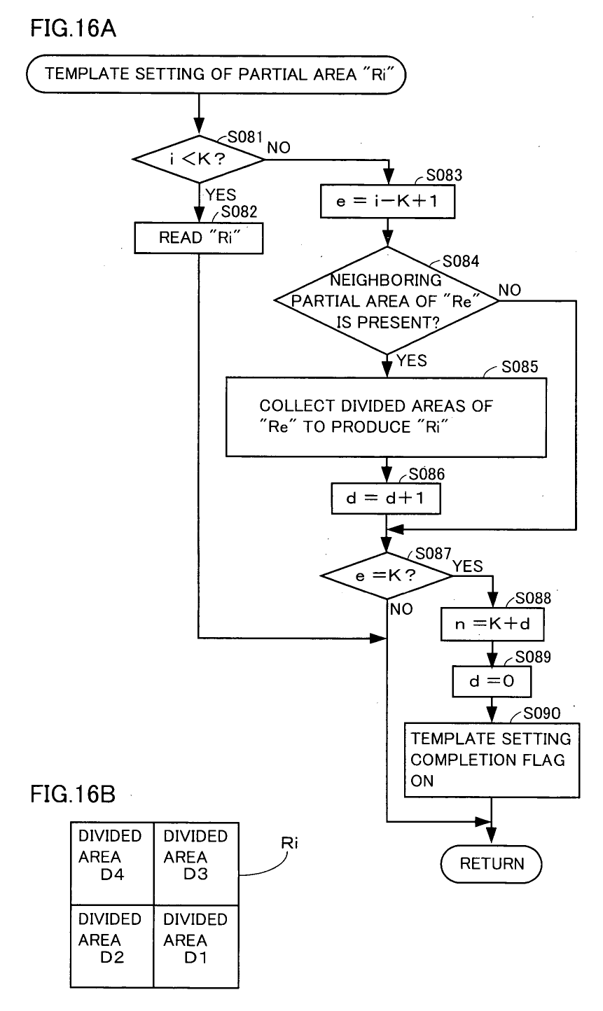

FIG. 16A is a flowchart illustrating a subroutine program of template setting of partial area “Ri” by template setting unit 111 in the third embodiment. First, it is determined in step S081 whether the current value of “i” is smaller than the value of “K” set in the foregoing step S074 or not. When the above current value of “i” is smaller the value of “K”, the image data of the boundary-including partial area is not yet used so that the image data of neighboring partial area “Ri” registered in registered data storing unit 202 is read in step S082. The template matching processing is executed with the image data thus read (see steps S005-S007).

When the above current value of “i” is not smaller than the value of “K”, the template matching is to be performed in this stage with the image data of boundary-including partial area. In this case, the result of determination in step S081 becomes “NO”, and arithmetic of (e=i−K+1) is performed in step S083. In next step S084, it is determined whether four neighboring partial areas including “Re” at the upper left are present or not. The value of “e” increases one by one to attain successively, e.g., 1, 2, 3 . . . in response to every increase of the value of “i”. Since the initial value of “e” is “1”, it is determined for the first execution of step S084 whether the neighboring partial areas including “R1” at the upper left are present or not. Referring to FIG. 15B, “Ri” is the partial area at the upper left end of the input image. The four neighboring partial areas including “R1” at the upper left are “R1”, “R2”, “R6” and “R7”. Consequently, the determination is performed in step S084 to provide the result of “YES”, and then the flow proceeds to step S085. Each neighboring partial area “Ri” illustrated in FIG. 15B is formed of image data of four divided areas D1, D2, D3, and D4 as illustrated in FIG. 16B. For example, when the value of “e” is “1”, the processing is performed in step S085 to collect or gather the data of divided area D1 of “R1”, the data of divided area D2 of upper right partial area “R2”, the data of divided area D3 of lower left partial area “R6” and the data of divided area D4 of lower right partial area “R7” to produce the image data of partial area “Ri”. Thus, referring to FIG. 15B, the processing produces the image data of the boundary-including partial area having a center matching with a crossing point of the boundaries of the four neighboring partial areas R1, R2, R6 and R7.

In next step S086, “1” is added to the value of “d”.

Referring to FIG. 15B, four neighboring partial areas including one of, e.g., nine partial areas R5, R10, R15, R20, and R21-R25 at the upper left are not present. In connection with these partial areas, the result of determination in step S084 is “NO”, and the processing in steps S085 and S086 is not performed. Consequently, the value of “d” matches with the number of the boundary-including partial areas.

In next step S087, it is determined whether the value of “e” is equal to the value of “K” or not. If it is not yet equal, this subroutine program ends.

Every time “1” is added to the value of “i” (see step S008), the processing in steps S083-S087 is repeated. When the value of “i” reaches “2K”, and thus when the value of “e” attains “K”, the result of determination in step S087 becomes “NO”, and the processing in step S088 is performed according to “n=K+d”. Consequently, the value of “n” is equal to a sum of the number of the neighboring partial areas, which are set in the input image without an overlap, and the number of image data items corresponding to the boundary-including partial areas produced in step S085. In next step S089, “0” is assigned to “d”, and the template setting completion flag is set to “ON” in step S090.

### Fourth Embodiment

In a fourth embodiment, the processing of producing the image data corresponding to the overlapping partial area already described in connection with the third embodiment is applied to the second embodiment.

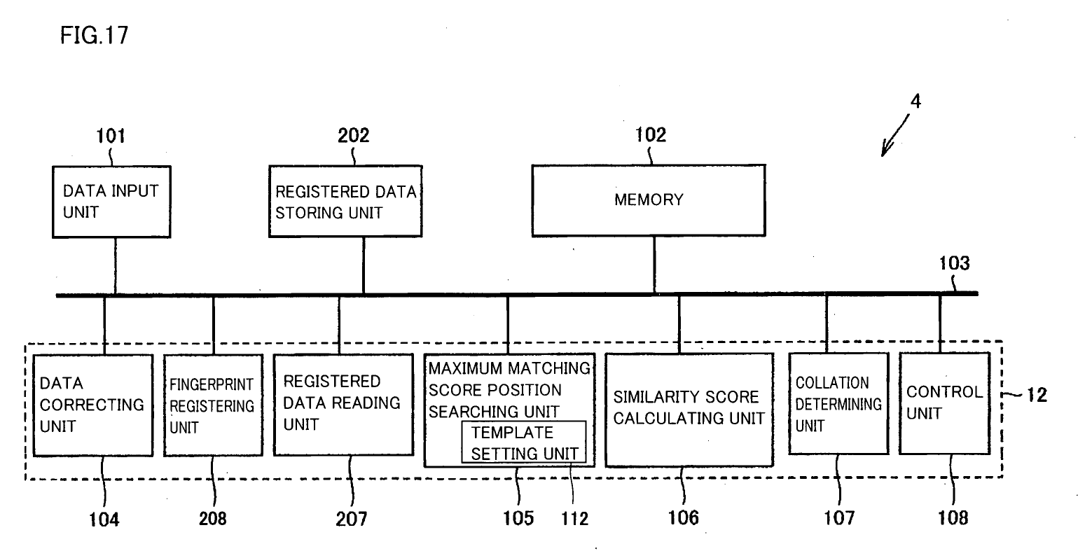

FIG. 17 illustrates a structure of an image collating apparatus 4 of the fourth embodiment. The image registering processing in this embodiment is the same as that in FIG. 14, and the collating processing is the same as that in FIG. 3. The fourth embodiment differs from the foregoing embodiments in specific contents of processing of extracting “Ri” illustrated in T10 of FIG. 14 of a fingerprint registering unit 208 as well as specific contents of a subroutine program of the template setting processing of partial area “Ri” performed by a template setting unit 112.

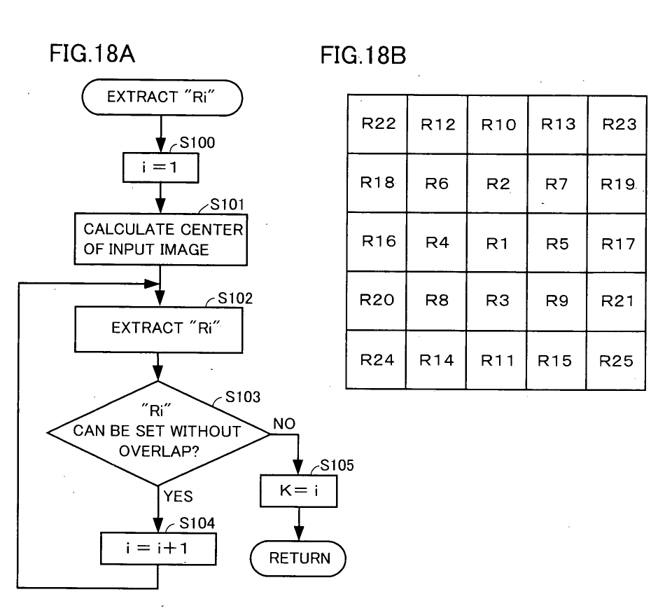

Referring to FIG. 18A, description will now be given on the contents of the subroutine program for extracting “Ri” by fingerprint registering unit 208. In step S100, “i” is initialized to “1”. In next step S101, the center of the input image is calculated. In next step S102, neighboring partial area “Ri” is extracted from a position near the calculated center. In next step S103, it is determined whether neighboring partial area “Ri” can be set in the input image without an overlap. When there is a residual area allowing setting of the neighboring partial area, the value of “i” is updated by adding “1” thereto in step S104, and the flow returns to step S102.

The loop in steps S102-S104 is repeated, and “1” is added to the value of “i” in response to every repetition. When neighboring partial areas “Ri” are set throughout the input image without an overlap, the processing in step S105 is performed to set the value of “i” to “K”, and this subroutine program ends.

Since neighboring partial areas “Ri” are extracted from the positions near the center in step S102, the neighboring partial areas are set as illustrated in FIG. 18B. More specifically, neighboring partial areas “Ri” are set in a matrix form of five rows and five columns. In FIG. 16B, neighboring partial area “R1” is first set in the central image position at the third row from the top and the third column from the left in FIG. 16B. Then, area “R2” is set above “R1”, next area “R3” is set under “R1”, area “R4” is set to the left of “R1”, and then area “R5” is set to the right of “R1”. In this manner, neighboring partial areas “Ri” are successively set from the center toward the periphery, and last neighboring partial area “R25” is set at the lower right corner.

In the case of FIG. 18B, twenty-five neighboring partial areas “Ri” are formed in total. Consequently, the value of “K” set in step S105 is equal to 25. Thus, “K” indicates the total number of the neighboring partial areas which are spread in the input image without an overlap.

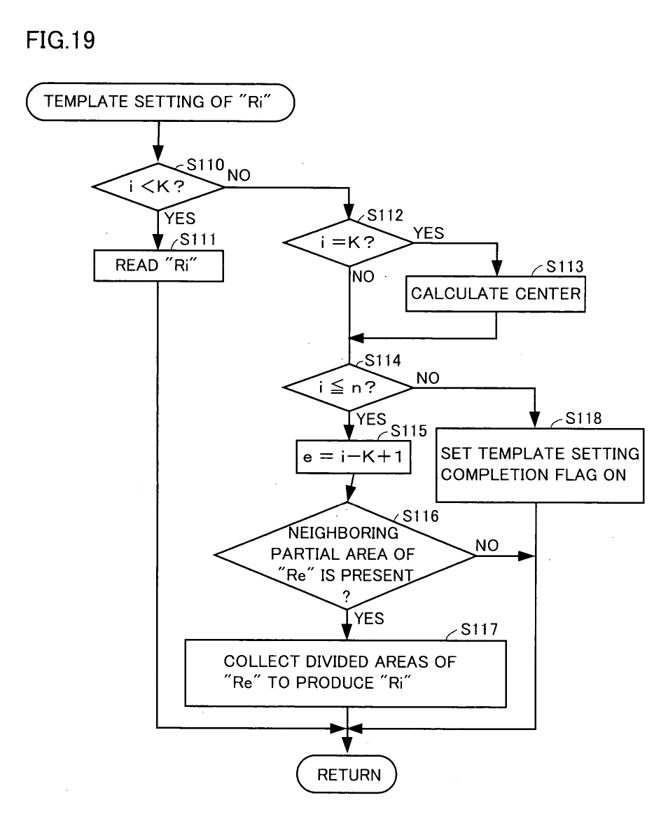

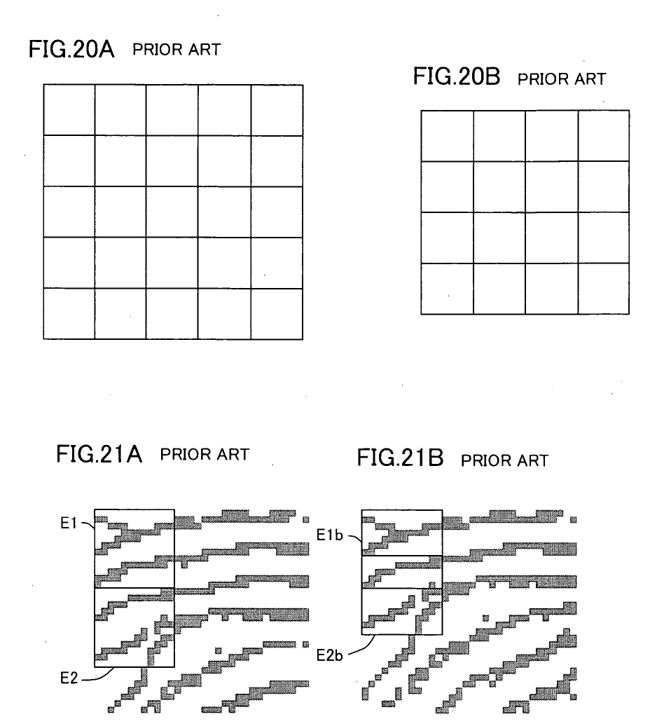

FIG. 19 is a flowchart illustrating a subroutine program of the template setting processing of partial area “Ri” performed by template setting unit 112. First, it is determined in step S110 whether the current value of “i” is smaller than the value of “K” set in step S105 or not. When it is smaller than the value of “K”, the collation is to be still performed using the image of the neighboring partial area, and therefore, neighboring partial area “Ri” stored in registered data storing unit 202 is read in step S11.

When the value of “i” is equal to or larger than K, the image of the boundary-including partial area is to be used in this stage so that it is determined in step S112 whether the values of “i” and “K” are equal to each other or not. When these are equal, i.e., when the process is in the first stage after it becomes necessary to use the boundary-including partial area, the center of the input image is calculated in step S113. In next step S114, it is determined whether the value of “i” is equal to or smaller than the value of “n” or not. This “n” is the same as that in foregoing step S046, and indicates the total number of the partial areas used for the collation. This value is predetermined. The value of “n” is larger than the total number (i.e., 25 in the case of FIG. 18B) of the neighboring partial areas in the state where the neighboring partial areas are spread throughout the input image without an overlap, and is smaller than the total number of the partial areas in the state where the boundary-including partial areas are spread throughout the neighboring partial areas.

When the current value of “i” is equal to or smaller than the value of “n”, calculation of (e=i−K+1) is performed in step S115, and it is determined in step S116 whether the four neighboring partial areas including neighboring partial area “Re” at the upper left are present or not. When these are present, the processing is performed in step S117 to collect or gather the data of divided area D1 of neighboring partial area “R1”, the data of divided area D2 of the upper right partial area, the data of divided area D3 of the lower left partial area and the data of divided area D4 of the lower right partial area to produce the image data of boundary-including partial area “Ri” from the collected data. The processing in these steps S116 and S117 are the same as those in the foregoing steps S084 and S085.

The processing in steps S114-S117 is repeated, and “1” is added to the value of “i” in response to every repetition (see step S008). When the value of “i” exceeds the value of “n”, the result of determination in step S114 becomes “NO”, and the template setting completion flag is set to “ON” in step S118 so that the subroutine program ends.

In the third and fourth embodiments, the image data of the neighboring partial area extracted from the input image is registered in registered data storing unit 202. This registering processing may be configured to store the neighboring partial area in registered data storing unit 202 corresponding to the plurality of items of image data (fingerprint data) to be collated. For this configuration, registered data storing unit 202 must store the data of the neighboring partial areas of the plurality of items of image data. In the collating operation, however, the data of the boundary-including partial areas required for the collation is produced using the data of the neighboring partial areas. Therefore, it is not necessary to store additionally the data of the boundary-including partial areas in registered data storing unit 202, which results in an advantage that increase in storage capacity of the registered data storing unit 202 can be suppressed as far as possible.

### Fifth Embodiment

The processing function for the image collation already described is implemented by a program. In this embodiment, the program is stored in a computer readable recording medium.

In this embodiment, the recording medium may be a memory required for the processing by the computer illustrated in FIG. 2, and may be a program medium itself such as memory 624. Also, the recording medium may be removably attached to an external storage device of the computer, or a recording medium storing the program in a manner allowing reading via the external storage device. This external storage device may be a magnetic tape drive (not shown), FD drive 630, CD-ROM drive 640 or the like, and the recording medium may be a magnetic tape (not shown), FD 632, CD-ROM 642 or the like. In any case, the program recorded on each recording medium may be accessed and executed by CPU 622, or the program may be once read from the recording medium and loaded to a prescribed program storage area in FIG. 2, such as a program storage area of memory 624, and then read and executed by CPU 622. The program for loading is stored in advance in the computer.

Here, the recording medium mentioned above is detachable from the computer body. A medium fixedly carrying the program may be used as the recording medium. Specific examples may include tapes such as magnetic tapes and cassette tapes, disks including magnetic disks such as FD 623 and fixed disk 626 and optical disks such as CD-ROM 642/MO(Magneto-Optical disk)/MD(Mini Disc)/DVD(Digital Versatile Disc), cards such as an IC card (including memory card)/optical card, and semiconductor memories such as a mask ROM, EPROM (Erasable and Programmable ROM), EEPROM (Electrically EPROM) and a flash ROM.

The computer shown in FIG. 2 has a configuration that allows connection to communication network 300 including the Internet for establishing communication. Therefore, the program may be downloaded from communication network 300 and held on a recording medium in a non-fixed manner. When the program is downloaded from communication network 300, the program for downloading may be stored in advance in the computer, or it may be installed in advance from a different recording medium.

The contents stored in the recording medium are not limited to a program, and may include data.

According to the first to fifth embodiments described above, even when the sensor area is small as illustrated, e.g., in FIG. 6B, the number of the partial areas can be increased by setting the partial areas as illustrated in FIG. 6B, and thereby the accuracy can be improved.

Further, in the process of collating the images, e.g., in FIGS. 7A and 7B, partial areas E1, E2 and E3 having overlaps are set as illustrated in FIG. 7A. When the search is made for the maximum matching score position of partial areas E1, E2 and E3 in FIG. 7B, the positions indicated by E1b, E2b and E3b are obtained, respectively, and large differences occur between the movement vectors as compared with the prior art so that it can be easily detected that these images are different from each other.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image collating apparatus for collating first and second images with each other, comprising:
partial area setting means for setting a plurality of partial areas for use in template matching in said first image;
maximum matching score position searching means for searching for a maximum matching score position being a position in said second image of the partial area attaining a maximum matching score in said second image, corresponding to each of the images of the plurality of partial areas set by said partial area setting means;
similarity score calculating means for calculating a similarity score between said first and second images from information related to said partial areas exhibiting a positional relationship quantity falling within a predetermined range among said positional relationship quantities of said plurality of partial areas, and outputting said similarity score as an image similarity score; and
determining means for determining whether said first and second images match with each other or not, based on said image similarity score output from said similarity score calculating means, wherein
the positional relationship quantity represents a positional relationship between a position of said partial area in said first image and said maximum matching score position corresponding to said partial area, and
said partial area setting means includes:
neighboring partial area setting means for setting a plurality of neighboring partial areas located in said first image and neighboring to each other without an overlap, and
boundary-including partial area setting means for setting a boundary-including partial area located on said neighboring partial areas set by said neighboring partial area setting means and in a position including a boundary between said neighboring partial areas, and
said neighboring partial areas and said boundary-including partial area are set as said plurality of partial areas.

2. The image collating apparatus according to claim 1, wherein
said plurality of partial areas are the partial areas all having the same rectangular shape,
said neighboring partial areas are set to spread throughout said first image, and
said boundary-including partial area includes a crossing point of the boundaries formed by the four neighboring partial areas neighbor to each other.

3. The image collating apparatus according to claim 1, wherein
said boundary-including partial area is the partial area restricted to a position including the boundary between the neighboring partial areas clearly exhibiting a feature of the image among all the neighboring partial areas.

4. The image collating apparatus according to claim 3, wherein
said similarity score calculating means executes the similarity score calculation while placing a larger weight on the similarity score calculation for said restricted boundary-including partial area clearly exhibiting the feature of said image as compared with the calculation for the other partial areas.

5. The image collating apparatus according to claim 1, wherein
said first and second images are derived from a living body.

6. The image collating apparatus according to claim 5, wherein
the image derived from said living body is an image derived from a fingerprint.

7. An image collating apparatus for collating first and second images with each other comprising:
partial area image data storing means for storing image data of a plurality of neighboring partial areas set in said first image for use in template matching and neighboring to each other without an overlap;
boundary-including partial area image data producing means for producing image data of a boundary-including partial area including a boundary between said neighboring partial areas neighboring to each other, and particularly producing the image data of said boundary-including partial area by collecting the image data of portions overlapping with said boundary-including partial area and included in the image data of said neighboring partial areas neighboring to each other and stored in said partial area image data storing means;
image input means for inputting said second image;
maximum matching score position searching means for searching for a maximum matching score position being a position in said second image of the partial area attaining a maximum matching score in said second image, corresponding to each of the images of the plurality of partial areas including the images formed of the image data of the plurality of neighboring partial areas stored in said partial area image data storing means and the image formed of the image data of said boundary-including partial area produced by said boundary-including partial area image data producing means;
similarity score calculating means for calculating a similarity score between said first and second images from information related to said partial areas exhibiting a positional relationship quantity falling within a predetermined range among said positional relationship quantities of said plurality of partial areas, and outputting said similarity score as the image similarity score; and
determining means for determining whether said first and second images match with each other or not, based on said image similarity score output from said similarity score calculating means, wherein
the positional relationship quantity represents a positional relationship between a position of said partial area in said first image and said maximum matching score position corresponding to said partial area.

8. The image collating apparatus according to claim 7, wherein
said plurality of partial areas are the partial areas all having the same rectangular shape,
said neighboring partial areas are set to spread throughout said first image, and
said boundary-including partial area includes a crossing point of the boundaries formed by the four neighboring partial areas neighbor to each other.

9. The image collating apparatus according to claim 7, wherein
said boundary-including partial area is the partial area restricted to a position including the boundary between the neighboring partial areas clearly exhibiting a feature of the image among all the neighboring partial areas.

10. The image collating apparatus according to claim 9, wherein
said similarity score calculating means executes the similarity score calculation while placing a larger weight on the similarity score calculation for said restricted boundary-including partial area clearly exhibiting the feature of said image as compared with the calculation for the other partial areas.

11. The image collating apparatus according to claim 7, wherein
said first and second images are derived from a living body.

12. The image collating apparatus according to claim 11, wherein
the image derived from said living body is an image derived from a fingerprint.

13. An image collating method for collating first and second images with each other, comprising:
a partial area setting step of setting a plurality of partial areas for use in template matching in said first image;
a maximum matching score position searching step of searching for a maximum matching score position being a position in said second image of the partial area attaining a maximum matching score in said second image, corresponding to each of the images of the plurality of partial areas set in said partial area setting step,
a similarity score calculating step of calculating a similarity score between said first and second images from information related to said partial areas exhibiting a positional relationship quantity falling within a predetermined range among said positional relationship quantities of said plurality of partial areas, and outputting said similarity score as an image similarity score; and
a determining step of determining whether said first and second images match with each other or not, based on said image similarity score output in said similarity score calculating step, wherein
the positional relationship quantity represents a positional relationship between a position of said partial area in said first image and said maximum matching score position corresponding to said partial area, and
said partial area setting step includes a neighboring partial area setting step of setting a plurality of neighboring partial areas located in said first image and neighboring to each other without an overlap, and
a boundary-including partial area setting step of setting a boundary-including partial area located on said neighboring partial areas set in said neighboring partial area setting step and in a position including a boundary between said neighboring partial areas, and
said neighboring partial areas and said boundary-including partial area are set as said plurality of foregoing partial areas.

14. An image collating program product causing a computer to execute an image collating method for collating first and second images with each other, said image collating method comprising:
a partial area setting step of setting a plurality of partial areas for use in template matching in said first image;
a maximum matching score position searching step of searching for a maximum matching score position being a position in said second image of the partial area attaining a maximum matching score in said second image, corresponding to each of the images of the plurality of partial areas set in said partial area setting step,
a similarity score calculating step of calculating a similarity score between said first and second images from information related to said partial areas exhibiting a positional relationship quantity falling within a predetermined range among said positional relationship quantities of said plurality of partial areas, and outputting said similarity score as an image similarity score; and
a determining step of determining whether said first and second images match with each other or not, based on said image similarity score output in said similarity score calculating step, wherein
the positional relationship quantity represents a positional relationship between a position of said partial area in said first image and said maximum matching score position corresponding to said partial area, and
said partial area setting step includes a neighboring partial area setting step of setting a plurality of neighboring partial areas located in said first image and neighboring to each other without an overlap, and
a boundary-including partial area setting step of setting a boundary-including partial area located on said neighboring partial areas set in said neighboring partial area setting step and in a position including a boundary between said neighboring partial areas, and
said neighboring partial areas and said boundary-including partial area are set as said plurality of foregoing partial areas.

15. A machine readable recording medium storing an image collating program causing a computer to execute an image collating method for collating first and second images with each other, said image collating method comprising:
a partial area setting step of setting a plurality of partial areas for use in template matching in said first image;
a maximum matching score position searching step of searching for a maximum matching score position being a position in said second image of the partial area attaining a maximum matching score in said second image, corresponding to each of the images of the plurality of partial areas set in said partial area setting step,
a similarity score calculating step of calculating a similarity score between said first and second images from information related to said partial areas exhibiting a positional relationship quantity falling within a predetermined range among said positional relationship quantities of said plurality of partial areas, and outputting said similarity score as an image similarity score; and
a determining step of determining whether said first and second images match with each other or not, based on said image similarity score output in said similarity score calculating step, wherein
the positional relationship quantity represents a positional relationship between a position of said partial area in said first image and said maximum matching score position corresponding to said partial area, and
said partial area setting step includes a neighboring partial area setting step of setting a plurality of neighboring partial areas located in said first image and neighboring to each other without an overlap, and
a boundary-including partial area setting step of setting a boundary-including partial area located on said neighboring partial areas set in said neighboring partial area setting step and in a position including a boundary between said neighboring partial areas, and
said neighboring partial areas and said boundary-including partial area are set as said plurality of foregoing partial areas.

16. An image collating method for collating first and second images with each other, comprising:
a partial area image data storing step of storing image data of a plurality of neighboring partial areas set in said first image for use in template matching and neighboring to each other without an overlap;
a boundary-including partial area image data producing step of producing image data of a boundary-including partial area including a boundary between said neighboring partial areas neighboring to each other, and particularly producing the image data of said boundary-including partial area by collecting the image data of portions overlapping with said boundary-including partial area and included in the image data of said neighboring partial areas neighboring to each other and stored in said partial area image data storing step;
an image input step of inputting said second image;
a maximum matching score position searching step of searching for a maximum matching score position being a position in said second image of the partial area attaining a maximum matching score in said second image, corresponding to each of the images of the plurality of partial areas including the images formed of the image data of the plurality of neighboring partial areas stored in said partial area image data storing step and the image formed of the image data of said boundary-including partial area produced in said boundary-including partial area image data producing step;
a similarity score calculating step of calculating a similarity score between said first and second images from information related to said partial areas exhibiting the positional relationship quantity falling within a predetermined range among said positional relationship quantities of said plurality of partial areas, and outputting said similarity score as an image similarity score; and
a determining step of determining whether said first and second images match with each other or not, based on said image similarity score output in said similarity score calculating step, wherein
the positional relationship quantity represents a positional relationship between a position of said partial area in said first image and said maximum matching score position corresponding to said partial area.

17. An image collating program product causing a computer to execute an image collating method for collating first and second images with each other, said image collating method comprising:
a partial area image data storing step of storing image data of a plurality of neighboring partial areas set in said first image for use in template matching and neighboring to each other without an overlap;
a boundary-including partial area image data producing step of producing image data of a boundary-including partial area including a boundary between said neighboring partial areas neighboring to each other, and particularly producing the image data of said boundary-including partial area by collecting the image data of portions overlapping with said boundary-including partial area and included in the image data of said neighboring partial areas neighboring to each other and stored in said partial area image data storing step;
an image input step of inputting said second image;
a maximum matching score position searching step of searching for a maximum matching score position being a position in said second image of the partial area attaining a maximum matching score in said second image, corresponding to each of the images of the plurality of partial areas including the images formed of the image data of the plurality of neighboring partial areas stored in said partial area image data storing step and the image formed of the image data of said boundary-including partial area produced in said boundary-including partial area image data producing step;
a similarity score calculating step of calculating a similarity score between said first and second images from information related to said partial areas exhibiting a positional relationship quantity falling within a predetermined range among said positional relationship quantities of said plurality of partial areas, and outputting said similarity score as an image similarity score; and
a determining step of determining whether said first and second images match with each other or not, based on said image similarity score output in said similarity score calculating step, wherein
the positional relationship quantity represents a positional relationship between a position of said partial area in said first image and said maximum matching score position corresponding to said partial area.

18. A machine readable recording medium storing an image collating program causing a computer to execute an image collating method for collating first and second images with each other, said image collating method comprising:
a partial area image data storing step of storing image data of a plurality of neighboring partial areas set in said first image for use in template matching and neighboring to each other without an overlap;
a boundary-including partial area, image data producing step of producing image data of a boundary-including partial area including a boundary between said neighboring partial areas neighboring to each other, and particularly producing the image data of said boundary-including partial area by collecting the image data of portions overlapping with said boundary-including partial area and included in the image data of said neighboring partial areas neighboring to each other and stored in said partial area image data storing step;
an image input step of inputting said second image;
a maximum matching score position searching step of searching for a maximum matching score position being a position in said second image of the partial area attaining a maximum matching score in said second image, corresponding to each of the images of the plurality of partial areas including the images formed of the image data of the plurality of neighboring partial areas stored in said partial area image data storing step and the image formed of the image data of said boundary-including partial area produced in said boundary-including partial area image data producing step;
a similarity score calculating step of calculating a similarity score between said first and second images from information related to said partial areas exhibiting a positional relationship quantity falling within a predetermined range among said positional relationship quantities of said plurality of partial areas, and outputting said similarity score as an image similarity score; and
a determining step of determining whether said first and second images match with each other or not, based on said image similarity score output in said similarity score calculating step, wherein
the positional relationship quantity represents a positional relationship between a position of said partial area in said first image and said maximum matching score position corresponding to said partial area.
